(19) United States
(12) Patent Application Publication
(10) Pub. No.: US 2025/0033030 A1
(43) Pub. Date: Jan. 30, 2025

(54) Aqueous Regenerants for Desorbing PFAS Substances From Sorbents

(71) Applicant: STRIDE, New Castle, DE (US)

(72) Inventors: Seetha Coleman Kammula, Newark, DE (US); Stephen Erwin Lyke, Wilmington, DE (US); Charles Powley, Wilmington, DE (US); Jessica Anton, Newark, DE (US); Xiaohuan Qin, Wilmington, DE (US); Jimmy Murillo Gelvez, New Castle, DE (US)

(21) Appl. No.: 18/782,671

(22) Filed: Jul. 24, 2024

Related U.S. Application Data
(60) Provisional application No. 63/515,688, filed on Jul. 26, 2023.

(51) Int. Cl. B01J 20/34; B01J 20/20; B01J 20/26; B01J 41/05; B01J 41/07; B01J 49/57; C02F 1/28; C02F 1/42; C02F 101/36

(52) U.S. Cl. CPC B01J 20/3475; B01J 20/20; B01J 20/262; B01J 20/3416; B01J 20/3425; B01J 41/05; B01J 41/07; B01J 49/57; C02F 1/283; C02F 1/285; C02F 1/42; C02F 2001/422; C02F 2101/36

(57) ABSTRACT

Desorption of Per and Polyfluoro Alkyl Substances (PFAS) from a PFAS laden sorbent into in a solvent-free aqueous solution using low concentrations of one or more cationic surfactants, with regeneration of the sorbent.

### CROSS-REFERENCE TO RELATED APPLICATIONS

This application claims benefit of U.S. Provisional Application No. 63/515,688, filed on Jul. 26, 2023, which is hereby incorporated herein by reference in its entirety BACKGROUND

The described and claimed inventive concept(s) relates to desorption of Per and Polyfluoro Alkyl Substances (PFAS) into water. More particularly, the present inventive concept(s) relates to recovering PFAS substances from materials, e.g., sorbents, onto which the PFAS substances have become attached, i.e., absorbed. The recovery, or desorption, can be accomplished in an aqueous system using surfactants, such as Hexadecyltrimethylammonium chloride, also known as Cetyl Trimethylammonium Chloride (CTAC), but without the need for a solvent, such as an alcohol. Useful sorbents can include, for example, cross-linked polymeric ammonium salts, generally known as Ionomers, as well as Granular Activated Carbon (GAC) and Anion Exchange Resins (AIX).

Per- and Polyfluoroalkyl substances (PFAS) are chemical compounds that have been shown to be highly persistent in the environment and in biological tissue, and they have been correlated with negative health impacts. According to the Agency for Toxic Substances and Disease Registry (ATSDR), for example, PFAS can increase cholesterol and suppress the immune system. PFAS can bio-accumulate, some having very long half-lives in humans, and they have been detected in the blood of a large percentage of the U.S. population. PFAS are very stable chemical compounds that can persist in soil and water for long periods of time, and they are highly mobile in soils and water.

PFAS encompass a family of man-made chemical compounds used in consumer and industrial applications, such as, for example, in the fabrication of non-stick cookware, grease-resistant paper, fast food wrappers, microwave popcorn bags, stain-resistant carpets and fabrics, water-resistant clothing and in cleaning and personal care product formulations and in firefighting foams. There are more than 3,000 PFAS chemical compounds that are in current use, or have previously been used, on the global market. While the origin of the environmental contamination is not known in most cases, current focus seems to be on Aqueous Film-Forming Foams (AFFF's), as 75% of the contaminated sites reported to date have some association with AFFF's. PFAS surfactant-containing AFFF formulations have been used extensively to extinguish hydrocarbon fuel fires at military bases, fire training sites, and oil refineries.

PFAS are very difficult to treat primarily because they are extremely stable compounds which include carbon-fluorine bonds. Carbon-fluorine bonds are the strongest bonds known in nature and are highly resistant to breakdown. Shorter chain PFAS are generally more hydrophilic, while longer chain PFAS are more hydrophobic. As a result, different PFAS behave differently in the environment, and in processes that would treat waters contaminated by them.

Most conventional water treatment systems and methods used to remove PFAS from water employ Granular Activated Carbon (GAC) and Anion Exchange Resins (AIX) as a sorbent. However, isolating the PFAS to thereby recover the GAC and AIX for re-use can be difficult. Current practices for regenerating PFAS-laden sorbents can involve use of high concentrations of an alcohol co-solvent (e.g., formulations which can contain up to 70% methanol) together with brines, followed by separate distillation to recover the co-solvent. In addition to being complex, such systems can require high concentrations of flammable organic solvents, which, in turn, necessitates the need for additional fire suppression safety systems.

U.S. Pat. No. 10,913,668 B2 describes a sustainable system for removing and concentrating per- and polyfluoroalkyl substances (PFAS) from water which includes an anion exchange resin configured to remove PFAS from water. The PFAS can then be removed from the anion exchange resin by a dual mechanism which includes desorption and anion exchange. Desorption may include providing a predetermined concentration of a solvent in a regenerant solution which is configured to displace hydrophobic tails of the PFAS on the backbone of the anion exchange resin with the solvent and providing a predetermined concentration of anions configured to displace hydrophilic heads of the PFAS with the anions. An optimized regenerant solution can include a mixture of a salt or a base, water and from about 50% up to about 70% methanol by volume.

Most anion exchange resins (AIX) tend to outperform GAC in PFAS removal service in terms of capacity and kinetics. AIX can be subdivided into strong base resins, which feature quaternary amine cationic sites to facilitate adsorption of anions, and weak base resins which feature primary, secondary, or tertiary amine sites. Each type can be further divided based on the polymer support to which the amine sites are attached, typically poly-styrene (styrenic) or poly-acrylate (acrylic). Some success has been reported regenerating PFAS-loaded acrylic AIX with aqueous brines. Non-regenerable AIX specified for PFAS service, however, are typically strong base, styrenic resins, as they provide the most effective PFAS removal. This disclosure focuses on regenerant solutions for all four types of AIX. Effective regeneration of most AIX from hydrophobic and hydrophilic PFAS has only been demonstrated with regenerant solutions that include significant (e.g., generally from 20% or more) amounts of methanol, or other organic solvents. (See Vakili, M., Cagnetta, G., Deng, S., Wang, W., Gholami, Z., Gholami, F., . . . Blaney, L. (2024). Regeneration of exhausted adsorbents after PFAS adsorption: A critical review. Journal of Hazardous Materials, 471 (134429), 1-22).

Thus, there is a need for improved alcohol-free aqueous regeneration solutions and systems that are effective for recovering PFAS from a sorbent and that do not present safety concerns

### SUMMARY OF THE INVENTION

According to one aspect, the inventive concept(s) described and claimed herein relates to an aqueous solution for removing PFAS from a PFAS-laden sorbent comprising at least 95% water by weight, from 0.02 to 2% by weight of one or more cationic surfactants, from 0 to 2% of an inorganic alkali, and from 0 to 4% of an inorganic salt.

In another aspect, the inventive concept(s) described and claimed herein relates to a method for desorbing, i.e., recovering, PFAS molecules from PFAS laden sorbents using an aqueous-only medium, i.e., solution, wherein the aqueous-only medium contains one or more cationic surfactants, such as Cetyl Trimethylammonium Chloride (CTAC). Sorbents are chemical compounds and materials which have the ability to attract and remove, i.e., isolate, PFAS from water. The term “sorbents” is used herein to include, but not be limited to, Granular Activated Carbon (GAC), Anion Exchange Resins (AIX) and ionomers, a class of self-supported crosslinked polymeric ammonium salts, all of which can adsorb PFAS molecules from an aqueous medium. The ionomers contemplated for use herein to adsorb PFAS molecules from an aqueous medium comprise one or more self-supported cross-linked polymeric ammonium salts of the type described in U.S. Patent Application 2023/0182113 A1, the teachings of which are incorporated herein by reference.

According to another aspect, the inventive concept(s) described and claimed herein relates to a method for regenerating an anion exchange resin configured to remove PFAS from water wherein an anion exchange resin laden with PFAS is subjected to an aqueous-only medium, i.e., solution, wherein the aqueous-only medium contains one or more cationic surfactants, such as Cetyl Trimethylammonium Chloride (CTAC).

According to another aspect, the inventive concept(s) described and claimed herein relates to a method for regenerating a bed of granular activated carbon (GAC) laden with PFAS which comprises subjecting the bed of granular activated carbon laden with PFAS to an aqueous-only medium which contains one or more cationic surfactants, such as Cetyl Trimethylammonium Chloride (CTAC).

### BRIEF DESCRIPTION OF THE DRAWINGS

Other objects, features and advantages will occur to those skilled in the art from the following description of a preferred embodiment and the accompanying drawings in which:

FIG. 1 illustrates a flow-through sorbent bed system according to one aspect of the inventive concept(s) described and claimed herein.

FIG. 2 is a bar graph which shows adsorption percentages from Example 3.

FIGS. 3A through 3E are bar graphs showing CTAC/NaCl desorption compared with other aqueous regenerants from Example 3.

FIGS. 4A though 4C are bar graphs which show alternative surfactant desorption performance from Example 4.

FIG. 5 is a table (Table 1) showing CTAC/NaCl desorption compared with other aqueous regenerants from Example 4.

### DETAILED DESCRIPTION OF THE INVENTION

Before explaining at least one embodiment of the presently disclosed and claimed inventive concept(s) in detail, it is to be understood that the presently disclosed and claimed inventive concept(s) is not limited in its application to the details of construction and the arrangement of the components or steps or methodologies set forth in the following description or illustrated in the drawings. The presently disclosed and claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed and claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed and claimed herein can be made and executed without undue experimentation in light of the present disclosure. While the articles and methods of the presently disclosed and claimed inventive concept(s) have been described in terms of particular embodiments, it will be apparent to those of skill in the art that variations may be applied to the articles and/or methods and in the steps or in the sequence of steps of the method described herein without departing from the concept, spirit and scope of the presently disclosed and claimed inventive concept(s). All such similar substitutes and modifications apparent to those skilled in the art are deemed to be within the spirit, scope and concept of the presently disclosed and claimed inventive concept(s) as defined by the appended claims.

As utilized in accordance with the present disclosure, the following terms, unless otherwise indicated, shall be understood to have the following meanings:

Use of the word “a” or “an” when used in conjunction with the term “comprising” in the claims and/or the specification may mean “one,” but it is also consistent with the meaning of “one or more,” “at least one,” and “one or more than one.” Use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

The term “ionomer” is used herein in the experiments which follow to mean a chemical structure, more particularly a cross-linked polymeric ammonium salt, having multiple nitrogen atoms bonded to four other atoms, of which at least one is a carbon atom. For example, in a primary ammonium ion, the nitrogen atom is bonded to three hydrogen atoms and one carbon atom. In a secondary ammonium ion, the nitrogen atom is bonded to two carbon atoms and two hydrogen atoms. In a tertiary ammonium ion, the nitrogen atom is bonded to three carbon atoms and one hydrogen atom. Finally, in a quaternary ammonium ion, the nitrogen atom is bonded to four carbon atoms.

In cross-linked polymeric ammonium salts contemplated for use according to the experiments which follow, at least 25% of the ammonium nitrogen atoms are secondary ammonium nitrogen atoms, preferably at least about 40% because secondary ammonium nitrogen atoms are associated with linear polymer segments, which reflect how well the polymer swells. A lower percentage of these nitrogen atoms will provide a low swelling polymer, and a higher number of these nitrogen atoms will be associated with polymer that either swells excessively or is predominantly soluble. Nitrogen atoms in linear polymer segments also allow closer access to their positive charge by the hydrophilic portion of PFAS molecules, resulting in stronger adsorption, than is allowed by tertiary or quaternary ammonium nitrogen atoms.

The quaternary ammonium surfactants contemplated for use herein are a sub-group of cationic surfactants which can be distinguished by four hydrocarbon, or substituted hydrocarbon, groups bonded to a positively charged nitrogen atom and by an anion, often a halide ion, which balances the positive charge of the nitrogen.

### Example 1: Adsorbing and Desorbing Aqueous Mixtures of PFBA, PFBS, PFOA, and PFOS

A series of tests were conducted to demonstrate the efficacy of aqueous solutions which contained 0.2 wt % CTAC at desorbing PFAS from sorbents loaded with four representative PFAS compounds. All experiments were completed at ambient temperature of approximately 25° C. The adsorption phase of the adsorption-desorption experiments used 20 ml of an aqueous PFAS mixture with nominal concentrations of 250 ppb each of perfluorooctanoic acid (PFOA), perfluorooctane sulfonic acid (PFOS), perfluorobutanoic acid (PFBA) and perfluorobutanesulfonic acid (PFBS) in a 125 ml bottle. The PFAS mixture was sampled and analyzed to determine the actual starting concentrations. Three sorbents including (i) an ionomer (a poly(alkylamine) ammonium salt) (ii) Filtrasorb® 400 granular activated carbon, and (iii) Calres® 2304, which is a strong base, styrenic, gel-type anion exchange resin, were used. Approximately 10 mg of sorbent was weighed into each bottle before adding the PFAS mixture. The bottles were shaken for 24 hours to approach adsorption equilibrium. After settling, the cleaned solutions were sampled through a wire mesh, and the sorbent was recovered by filtration through a similar fine mesh screen. For the desorption phase, the sorbent and screen were returned to the 125 ml bottles, and 20 ml of one of several candidate desorption solutions added. The bottles were shaken for another 22 hours with an interruption after the first hour for an early sample. Samples were again taken through a wire mesh screen, and all samples were analyzed by LC-MS-MS.

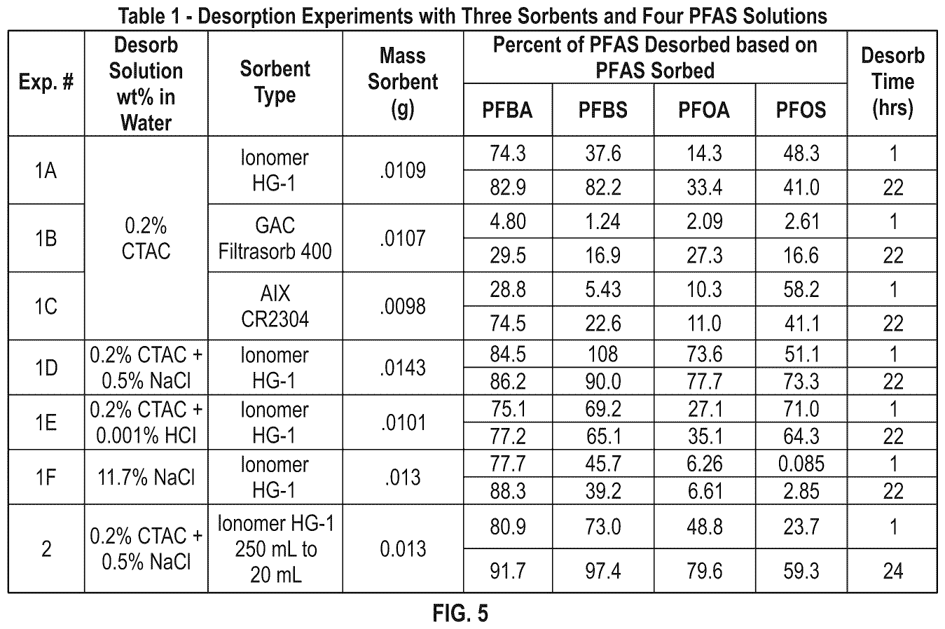

The adsorb phase of the adsorption-desorption experiments typically produced >98% adsorption of all four PFAS. FIG. 5 (Table 1) presents the fraction desorbed of each PFAS based on the fraction adsorbed. Compared with the 11.7% NaCl solution, just 0.2% CTAC showed significant desorption of all four PFAS from the ionomer, rather than selectively desorbing only shorter-chain PFBA and PFBS. Combining the CTAC with 0.5% NaCl showed further improvement, while adding a small amount of HCl was less effective. Although the best desorption results were obtained with the ionomer as a sorbent, under the conditions of this experiment, the aqueous solution which contained 0.2 wt % CTAC accomplished some desorption of all four PFAS with the GAC and AIX sorbents as well.

### Example 2: Adsorption Followed by Desorption at Higher Concentrations

An experiment was conducted similarly to the cases of Example 1 with the exception that the adsorption phase began with the same quantity of the four PFAS compounds dissolved in 250 ml of water, rather than in 20 ml of water. 10 mg of the ionomer (a poly(alkylamine) ammonium salt) was the sorbent, and the desorb solution was 20 ml of 0.2% by weight CTAC and 0.5% NaCl in water. In the adsorb phase, adsorption percentages were 96.4%, 98.1%, 97.4%, and 96.5% for PFBA, PFBS, PFOA and PFOS, respectively. Desorption percentages, based on the amounts adsorbed, are listed in the last row of FIG. 5 (Table 1). This experiment demonstrated PFAS desorption into a volume of solution less than a tenth of the volume from which they were adsorbed, with similar desorption percentages to the equal-volume Example 1.

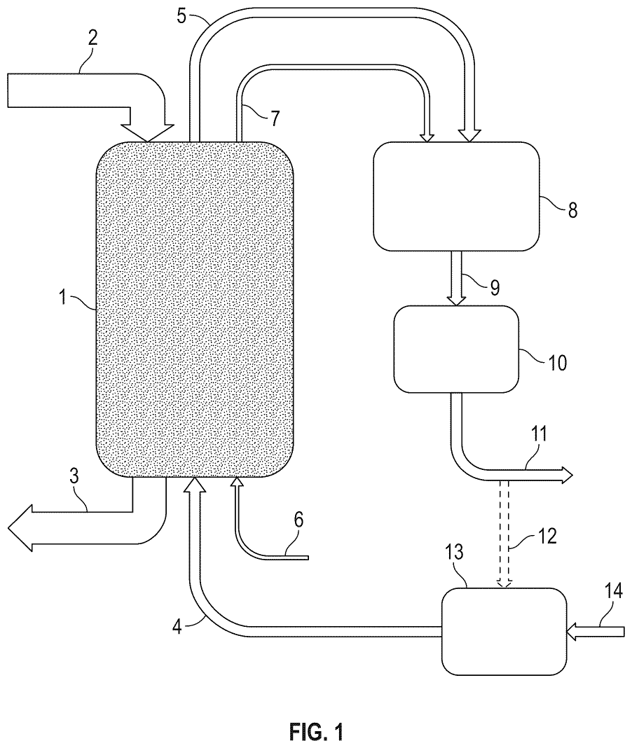

Desorption into a more concentrated solution can facilitate subsequent destruction of the originally adsorbed PFAS. Example 2 concentrated PFAS from a larger starting solution volume into a smaller desorbed solution in batch experiments, corresponding to a demonstrated concentration factor of about 10 times. However, Examples 1D and 2 demonstrate a potential for higher concentration factors in a flow-through system, such as illustrated in FIG. 1. In batch adsorption experiments, PFAS on the sorbent approach equilibrium with the final, reduced PFAS concentrations in the water, while in a flow-through system, PFAS on the sorbent approach equilibrium with higher concentrations in the feed water. Components in the regenerant solution shift the equilibrium between dissolved and adsorbed PFAS. In batch desorption experiments, the solution PFAS concentration approaches this new equilibrium with the final, depleted, sorbent while in a flow-through system illustrated in FIG. 1, regenerant solution exiting the top of the column approaches equilibrium with the maximum sorbent loading, corresponding to adsorption equilibrium with the original feed water. Taking the preceding considerations into account, from the data of Examples 1D and 2, concentration factors of about 1000 times or more can be projected for a flow-through sorbent bed system of the type shown in FIG. 1.

Referring now to FIG. 1, sorbet bed 1 is a closed vessel configured to contain a sorbet material. PFAS contaminated water is configured to enter sorbent bed 1 through inlet 2 during an adsorption phase of a repeating cycle of (i) adsorption; (ii) regeneration; and (iii) rinse. The adsorption phase of the cycle then repeats. Clean water is removed from sorbent bed 1 through exit line 3 during the adsorption phase. In operation, the adsorption phase can typically last for months. Adsorption is followed by a regeneration phase, which can last for hours or days, wherein aqueous regeneration solution enters sorbet bed 1 via inlet line 4 and is removed from sorbent bed 1 via outlet line 5. The regeneration phase is followed by a rinse phase, which can last for minutes or hours, wherein a rinsing water is introduced into sorbent bed 1 via inlet line 6 and is removed via outlet line 7. An accumulation vessel 8 is provided for receiving aqueous regeneration solution and rinse water. Accumulation vessel 8 is configured for mixing the regeneration solution and the rinse water which allows for accumulation of a concentrate comprising PFAS compounds that were desorbed from sorbent bed 1. The flow through system can also include means 9 for passing the concentrate to a PFAS destruction unit 10 configured with an outlet 11 communicating via line 11 with a disposal system (not shown) for PFAS-free waste. The flow through system can also include a recycle stream 12, and an aqueous solution supply unit 13 configured for receiving fresh regenerant solution via line 14, which is introduced into sorbent bed 1 via line 4.

### Example 3: Improved Aqueous Desorption from Multiple Ionic Sorbents

This example compares the performance of a CTAC/NaCl aqueous regenerant formulation with that of other aqueous regeneration solutions. Five sorbents were included in the tests: (i) the ionomer used in Example 1 (a poly(alkylamine) ammonium salt), designated HG-1, (ii) a second ionomer (a poly(alkylamine) ammonium salt that was prepared from polyethylene imine and dibromodecane using DMF/methanol as solvent according to the procedure described in U.S. Pat. No. 5,633,344, the teachings of which are incorporated herein by reference, designated HG-5, (iii) weak base acrylic anion exchange resin IRA67, (iv) weak base styrenic resin A111, and (v) strong base styrenic resin PFA694E. The adsorption phase of the adsorption-desorption experiments used 40 ml of an aqueous PFAS mixture with nominal concentrations of 55 ppb each of PFBA, PFBS, PFOA and PFOS in 50 mL centrifuge bottles. Approximately 10 mg of one of the sorbents was weighed into all but one of the bottles before adding the PFAS mixture. A sorbent-free bottle was processed as a control. The bottles were shaken for 24 hours to approach adsorption equilibrium. After settling, the cleaned solutions were sampled through a wire mesh, and the sorbent was recovered by filtration through a similar fine mesh screen. For the desorption phase, the sorbents and screens were returned to the original centrifuge bottles and 20 ml of one of the desorption solutions added to each. The bottles were shaken for another 24 hours, then allowed to settle for up to 24 hours. Samples were again taken through a wire mesh screen and all samples were analyzed by LC-MS-MS.

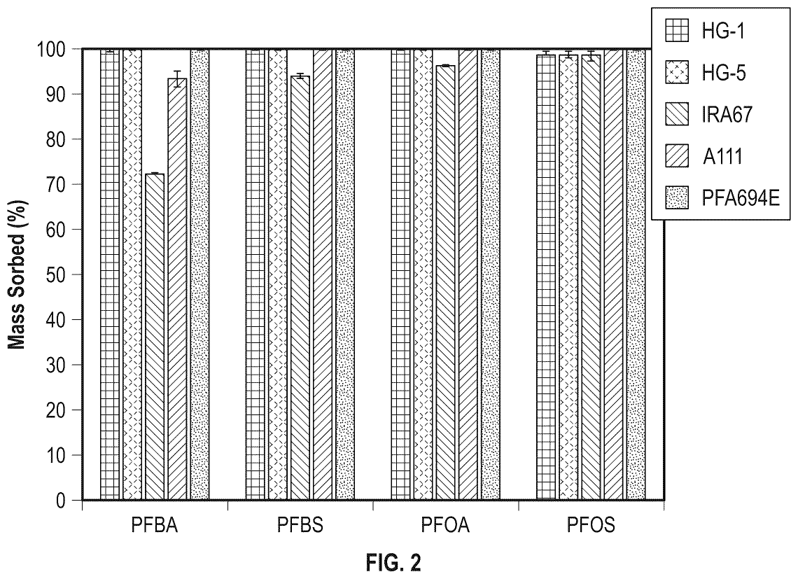

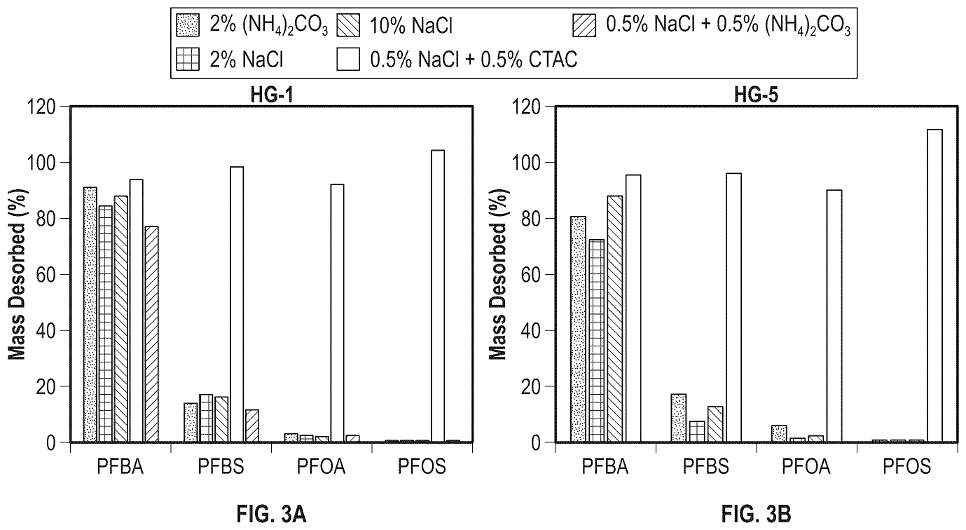

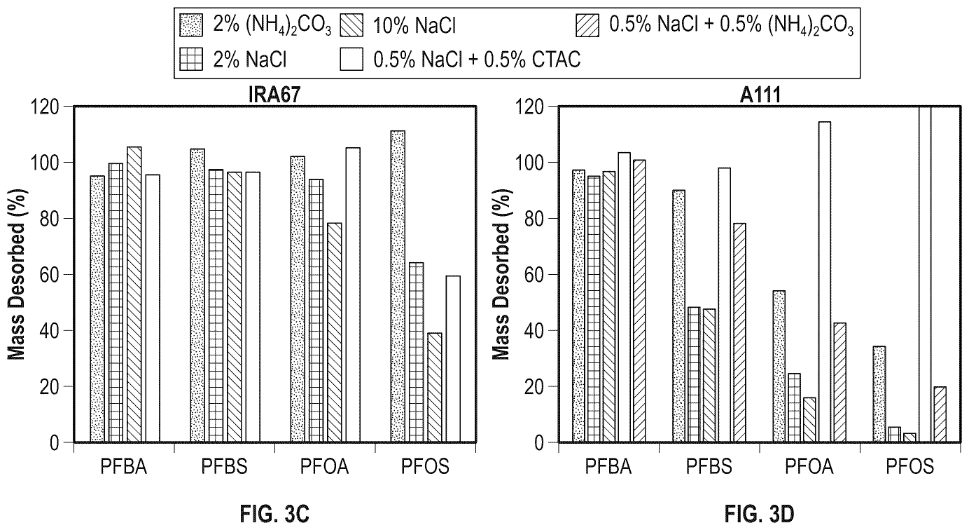

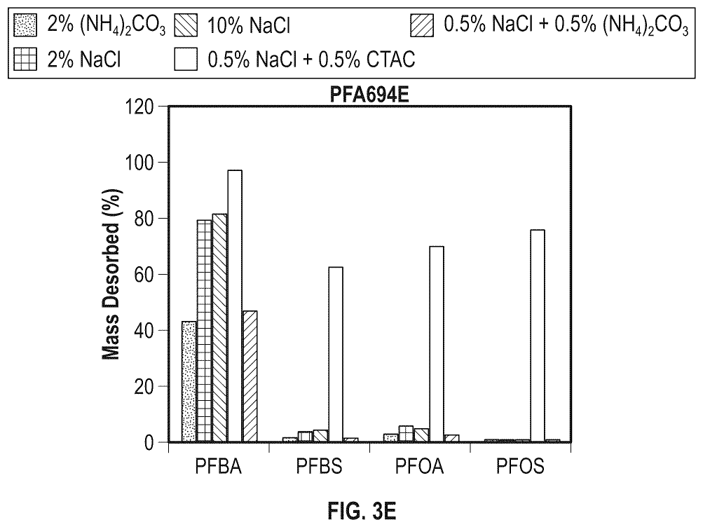

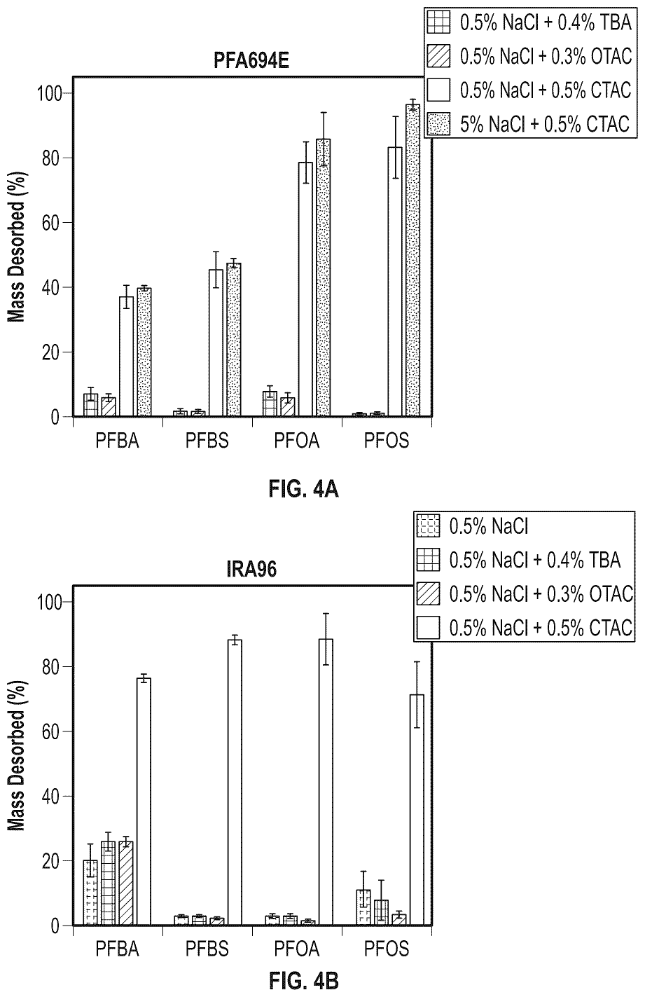

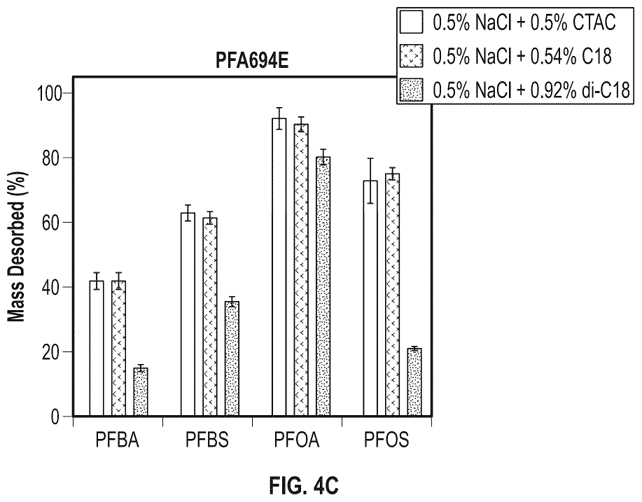

Adsorption percentages of the four PFAS by the five sorbents are plotted in FIG. 2. The ionomers and strong base styrenic resin PFA694E demonstrated the most complete adsorption, and the weak base styrenic resin A111 performed nearly as well, while adsorption by the weak base acrylic resin IRA67 was less complete. FIG. 2 presents desorption percentages based on the percentages adsorbed. All five of the aqueous regenerant solutions desorbed PFBA well from most of the sorbents. The advantage of the CTAC/NaCl aqueous regenerant solution is very apparent in the regeneration percentages of the other three PFAS from all the sorbents except for IRA67, where ammonium carbonate was more effective at desorbing PFOS. As noted earlier, IRA67 was less effective than the other sorbents at adsorbing the four PFAS.

### Example 4: Other Quaternary Ammonium Surfactants and Higher NaCl Level Tested

In addition to CTAC, four different quaternary ammonium surfactants were tested in a series of experiments: octyl-trimethyl-ammonium chloride (OTAC), tetrabutyl-ammonium chloride (TBA), octadecyl-trimethyl-ammonium chloride (C18) and dioctadecyl-dimethyl-ammonium chloride (di-C18). The tests were conducted with two styrenic resins: (i) strong base, gel-type PFA694E and (ii) weak base, macro-porous IRA96. For these screening tests, a flow apparatus was used with 1 cm deep beds of each sorbent in 0.8 cm inside diameter columns (sorbent volume approximately 0.5 mL). All tests were conducted at ambient temperature of approximately 25° C. Adsorption and desorption flows were in the same, downflow direction. Sorbents in the small beds were first pre-conditioned by passing through 20 ml of a solution of 0.5 wt % NaCl in 0.04 M HCl, followed by 30 ml of pure water. PFAS adsorption was from 20 ml of a solution containing PFBA, PFBS, PFOA and PFOS each at a nominal concentration of 250 ppb, passed through the beds at 0.5 ml/min. Desorption solutions tested with the PFA694E resin were 0.5 wt % CTAC with 0.5% NaCl in water, 0.5% CTAC with 5% NaCl in water, 0.3% OTAC with 0.5% NaCl in water, 0.4% TBA with 0.5% NaCl in water, 0.54% C18 with 0.5% NaCl in water, and 0.92% di-C18 with 0.5% NaCl in water. The differing weight percentages of the surfactants correspond to approximately the same molar concentrations. Each regenerant solution was tested in duplicate. With the IRA96 resin, desorption solutions tested included 0.5% NaCl in water as a control, 0.5 wt % CTAC with 0.5% NaCl in water, 0.3% OTAC with 0.5% NaCl in water, and 0.4% TBA with 0.5% NaCl in water. In each case, 20 ml of desorption solution was passed through the bed at 0.5 ml/min. Effluents from adsorption and desorption were collected separately and analyzed for PFAS by LC-MS-MS.

In the adsorption phase of the tests, 99% or more of each PFAS was adsorbed by both sorbents. Desorption percentages are presented in FIG. 5 (Table 1). From these results, we can conclude that increasing NaCl concentration from 0.5 to 5% was not of significant benefit in the improved aqueous regenerant formulation with 0.5% CTAC. We also conclude that, at least for the four PFAS tested in this example, neither OTAC nor TBA was an effective replacement for CTAC in the improved regenerant. We further conclude that C18 was an effective replacement for CTAC while di-C18, although more effective than OTAC or TBA, was less effective than CTAC. CTAC has a single n-alkyl chain of 16 carbons, while OTAC has a single 8-carbon chain (and three methyl groups), TBA has four 4-carbon chains, C18 has a single 18-carbon chain (and three methyl groups), and di-C18 has two 18-carbon chains (and two methyl groups). These results suggest a preference for quaternary ammonium surfactants with one n-alkyl chain at least 10 carbons long. The ideal surfactant may vary depending upon the mixture of PFAS and other contaminants adsorbed in a given application, and there may be an optimum n-alkyl chain length more or less than the 16-18 carbons of CTAC and C18.

What is claimed is:

1. An aqueous solution for removing PFAS from a PFAS-laden sorbent comprising at least 95% by weight water, from 0.02 to 2% by weight of one or more cationic surfactants, from 0 to 2% of an inorganic alkali, and from 0 to 4% of an inorganic salt.

2. The aqueous solution of claim 1 wherein the cationic surfactant is a quaternary ammonium surfactant.

3. The aqueous solution of claim 2 wherein the quaternary ammonium surfactant has an n-alkyl chain at least 10 carbons.

4. The aqueous solution of claim 3 wherein the quaternary ammonium surfactant is cetyltrimethylammonium chloride.

5. A method for regenerating a PFAS laden sorbent which comprises contacting the sorbent with an aqueous solution comprising from at least 95% by weight water, from 0.02 to 2% by weight of one or more cationic surfactants, from 0 to 2% by weight of an inorganic alkali, and from 0 to 4% by weight of an inorganic salt.

6. The method of claim 5 wherein the cationic surfactant is a quaternary ammonium surfactant.

7. The method of claim 6 wherein the quaternary ammonium surfactant has an n-alkyl chain at least 10 carbons.

8. The method of claim 7 wherein the quaternary ammonium surfactant is cetyltrimethylammonium chloride.
